(19) United States
(12) Patent Application Publication
(10) Pub. No.: US 2013/0014404 A1
(43) Pub. Date: Jan. 17, 2013

(54) GRAIN DRYER WITH DOUBLE PASS AIRFLOW

(71) Applicant: Brent J. BLOEMENDAAL, Zionsville, IN (US)

(72) Inventor: Brent J. BLOEMENDAAL, Zionsville, IN (US)

(73) Assignee: CTB, Inc., Milford, IN (US)

(21) Appl. No.: 13/545,705

(22) Filed: Jul. 10, 2012

Related U.S. Application Data
(60) Provisional application No. 61/506,773, filed on Jul. 12, 2011.

(51) Int. Cl. F26B 17/12; F26B 23/00; F26B 19/00

(52) U.S. Cl. 34/167; 34/212

(57) ABSTRACT

A continuous flow grain dryer includes airflow paths such that air passes through a grain column twice prior to exiting the grain dryer or being recirculated. The dual pass airflow defines a preheat zone in an upper portion of the grain flow paths adjacent an exhaust plenum. A heat zone is defined in the grain flow paths adjacent a high heat plenum and below the preheat zone. The dual pass airflow defines a temper zone in the grain flow paths adjacent a return plenum and below the heat zone. A cooling zone can be defined below the temper zone and adjacent the return plenum. A recirculating airflow path can provide fluid communication from the return plenum to the fan and back to the heat plenum. The burner is positioned outside the airflow path to feed ambient air into the recirculating airflow path, without recirculating airflow passing through the burner.

### CROSS-REFERENCE TO RELATED APPLICATIONS

This application is a continuation that claims the benefit of U.S. Provisional Application No. 61/506,773, filed on Jul. 12, 2011. The entire disclosure of the above application is incorporated herein by reference.

### FIELD

The present disclosure relates to grain dryers, and more particularly, to continuous flow grain dryers.

### BACKGROUND

This section provides background information related to the present disclosure which is not necessarily prior art.

Continuous flow grain dryers, such as those shown in U.S. Pat. Nos. 4,404,756, 4,268,971, and 5,467,535, which are incorporated herein by reference in their entirety, generally include two continuously moving columns of grain. Air discharged from a fan typically next passes through a burner and then through a grain column only once before being discharged or returned to the blower for recirculation. Recirculated air from volatile grains presents a risk of fire, since it typically needs to pass through the heater during the recirculation process where fines can be ignited. Such single pass airflow through the grain column, and such limitations on the ability to recirculate the air limits the efficiency of the grain drying operation.

Continuous flow grain dryers also typically subject the incoming grain immediately to the highest temperature air, which can shock the grain and negatively affecting grain quality. Similarly, when ambient air is used in the cooling process, the grain is typically subjected to an immediate change from very high temperature to ambient air passing through the column, again resulting in shock to the grain which can likewise negatively affect grain quality.

### SUMMARY

This section provides a general summary of the disclosure, and is not a comprehensive disclosure of its full scope or all of its features.

In one aspect of the disclosure a continuous flow grain dryer including a pair of adjacent grain flow paths through which the grain flows downwardly under the influence of gravity in a grain column is provided. A plurality of openings provide airflow paths from one side to an opposing side of each grain flow path. A central air plenum is positioned between the pair grain flow paths. A first divider separates the central air plenum into a higher pressure zone and a first lower pressure zone. A first enclosure laterally adjacent a first side of the higher pressure zone captures airflow exiting a first of the pair of grain columns from the higher pressure zone. The first enclosure defines a portion of a first airflow path through which the air passes from the first enclosure back through the first of the pair of grain columns and into the first lower pressure zone. A second enclosure is laterally adjacent a second side of the higher pressure zone to capture airflow exiting a second of the pair of grain columns from the higher pressure zone. The second enclosure defines a portion of a first airflow path through which the air passes from the second enclosure back through the second of the pair of grain columns and into the first lower pressure zone.

In another aspect of the disclosure a continuous flow grain dryer is provided, including a central plenum defined by a pair of adjacent grain flow paths and separated by a divider into a heat plenum and a return plenum. A recirculating airflow path provides fluid communication from the return plenum through a fan and back to the heat plenum. During operation, the return plenum is fed by airflow passing through grain columns in the pair of adjacent grain flow paths. A burner is positioned outside the recirculating airflow path providing heated air to the fan via a burner airflow path that joins to the recirculating airflow path. During operation, the burner is fed by ambient airflow from a burner inlet without any recirculating airflow passing through the burner.

In yet another aspect of the disclosure a four column continuous flow grain dryer is provided. Four longitudinally extending grain flow paths through which grain flows downwardly under the influence of gravity in a grain column are included. Each side of the four grain flow paths is defined by a series of angled panels operating as moisture equalizers. A plurality of elongated openings defined between each of the series of angled panels permit airflow through one side of each grain flow path, through each grain column, and through an opposing side of each grain flow path. A central air plenum is provided in each space between a first and second of the four grain flow paths and between a third and forth of the four grain flow paths. Two dividers separate each central air plenum into an exhaust plenum at the top, a heat plenum in the middle, and a return plenum at the bottom. An outer wall is positioned on each opposing side of the four grain flow paths and laterally adjacent a corresponding heat plenum to form an outer enclosure capturing airflow exiting an adjacent grain column from an outer side of an adjacent heat plenum. An inner enclosure is provided in each space between the second and the third of the four grain flow paths laterally adjacent each heat plenum to capture airflow exiting the second and third grain columns from an inner side of the heat plenum. Each enclosure defines a portion of a preheat airflow path through which air passes from the enclosure back through an adjacent grain column and into one of the exhaust plenums to create a preheat zone at the upper end of each grain column. High heat airflow paths from each heat plenum through adjacent grain columns into the enclosures create a high heat zone below the preheat zone. Each enclosure defines a portion of a temper airflow path through which air passes from each enclosure back through an adjacent grain column and into one of the return plenums to create a temper zone below each high heat zone. Ambient airflow paths are defined by a group of the plurality of openings at the lower end of each grain column through which ambient air passes through each grain column into one of the return plenums to define a cooling zone below each temper zone.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of one exemplary embodiment and not all possible implementations, and are not intended to limit the scope of the present disclosure.

FIG. 1 is a perspective view of one exemplary grain dryer in accordance with the present disclosure;

FIG. 2 is a simplified cross-sectional view showing the grain flow paths and certain airflow paths within the exemplary grain dryer of FIG. 1;

FIG. 3 is an internal view of one of the sub-plenums and showing the elongated airflow openings defined by the panels of the exemplary grain dryer of FIG. 1;

FIG. 4 illustrates a loop paddle conveyor which can be used to feed grain into the top of the grain flow paths in exemplary grain dryer of FIG. 1;

FIG. 5 illustrates a jump drag conveyor by which the output from each metering paddle conveyor can be joined to a single grain output in the exemplary grain dryer of FIG. 1;

FIG. 6 is a simplified perspective view illustrating various airflow paths of the exemplary grain dryer of FIG. 1;

FIG. 7 is a perspective view showing an outer shroud of the fan of the exemplary grain dryer of FIG. 1; and

FIG. 8 is a view showing the exhaust openings in the common back wall of the exemplary grain dryer of FIG. 1.

Corresponding reference numerals indicate corresponding parts throughout the several views of the drawings.

### DETAILED DESCRIPTION

Example embodiments will now be described more fully with reference to the accompanying drawings.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence of importance or order unless clearly indicated by the context. Thus, a first element, component, region, layer or section discussed below could be termed a second element, component, region, layer or section without departing from the teachings of the example embodiments.

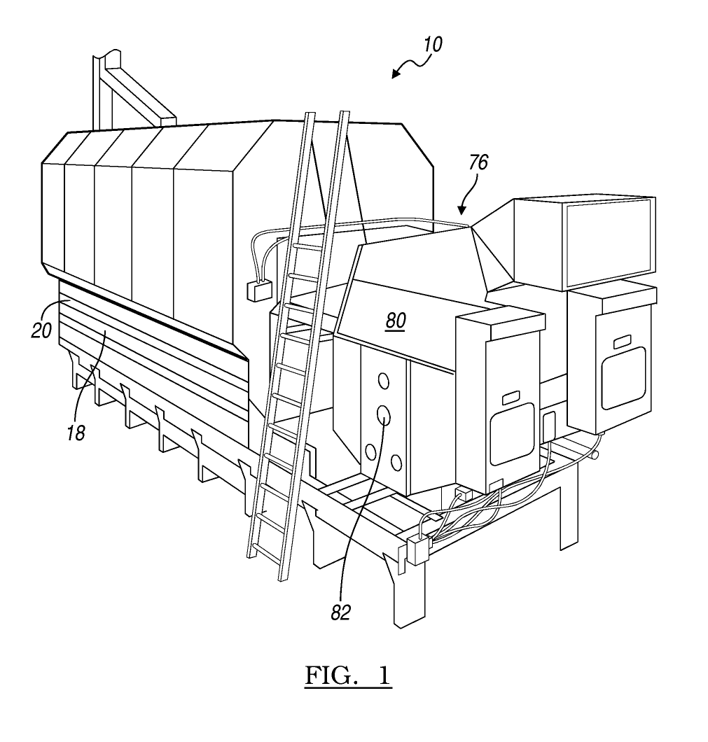

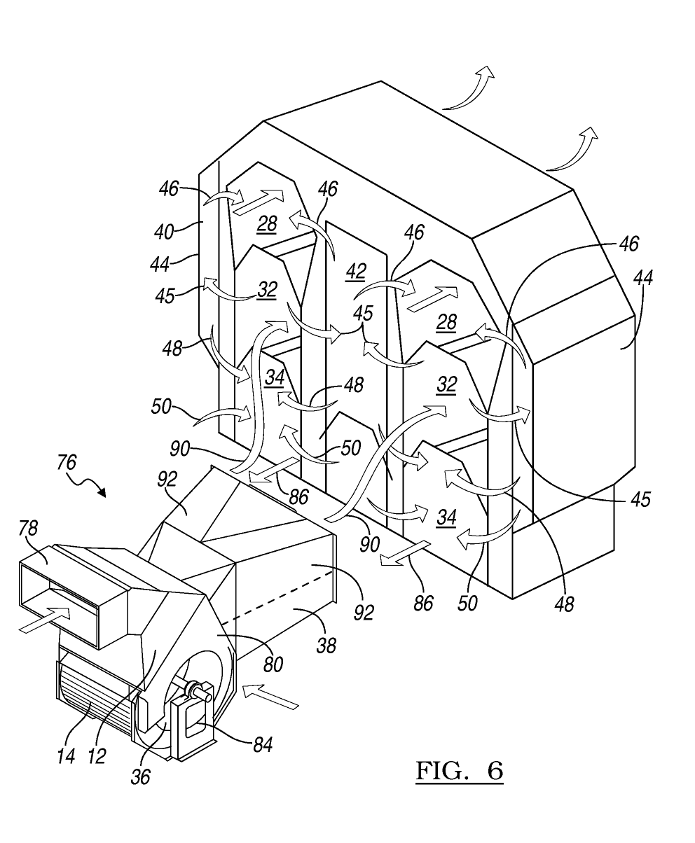

Referring to FIGS. 1 and 6, an exemplary embodiment of a continuous flow grain dryer 10 of the present disclosure can generally include an induced draft burner 12, and a double wide, double inlet centrifugal fan 14 providing double pass airflow through a plurality of grain columns.

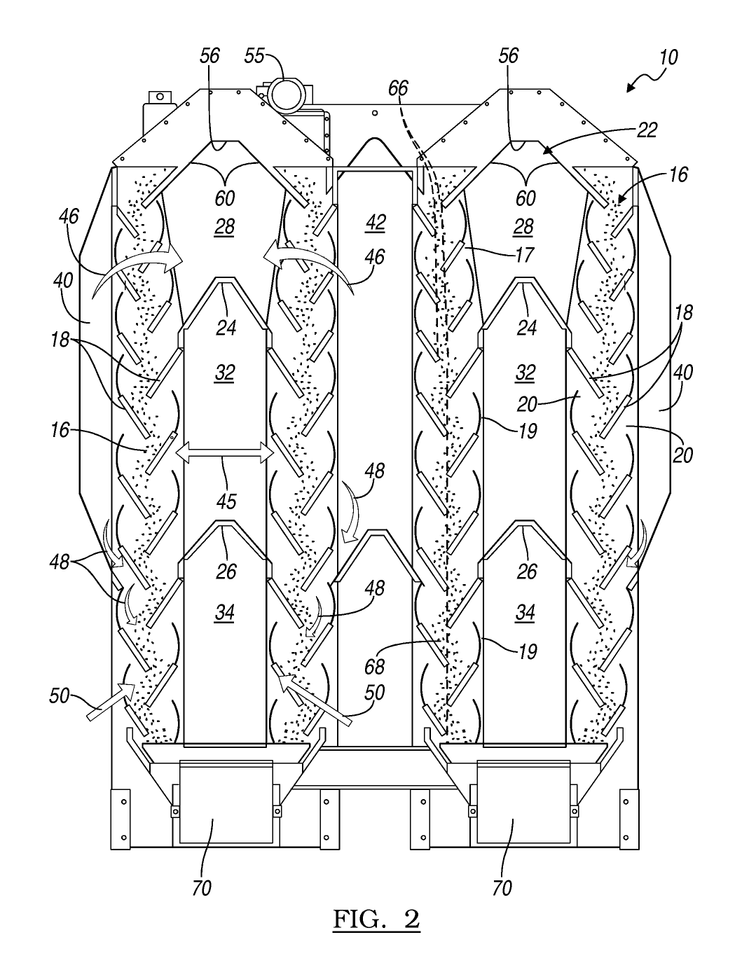

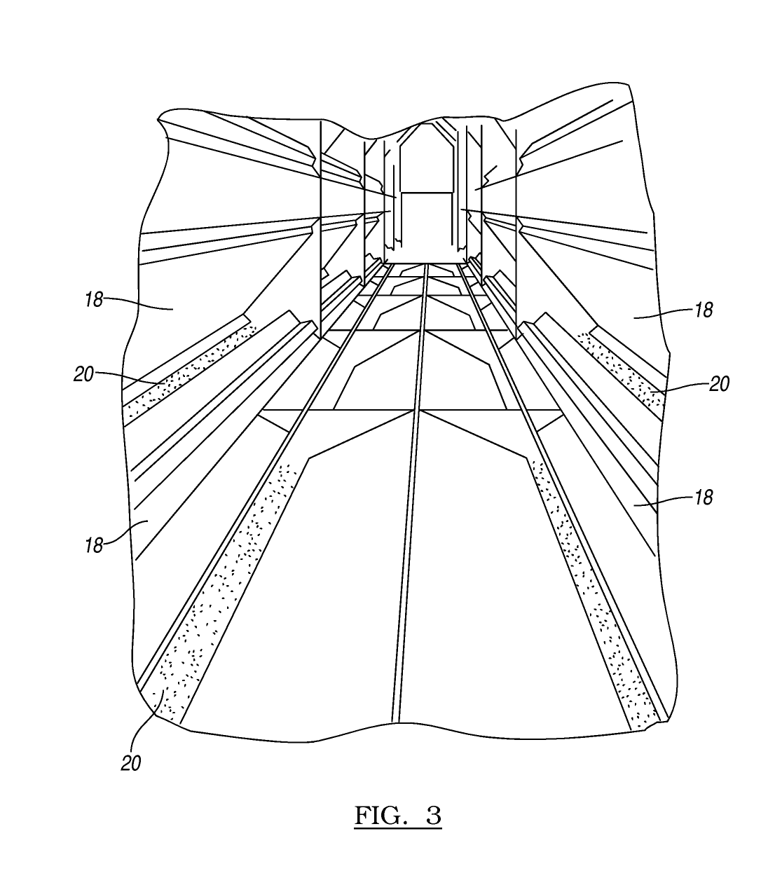

Referring to FIG. 2, this embodiment includes four adjacent grain flow paths 16 that define grain columns in use. In this exemplary embodiment, the adjacent grain flow paths 16 are longitudinally extending and therefore are completely separate from each other. Adjacent grain flow paths 16, however, can also exist in a circular grain dryer wherein opposing portions of a circular grain column can be considered to form adjacent grain flow paths 16. Each of the grain columns can result from an undulating grain flow path 16 that is defined by opposing sets of a plurality of panels 18 angled downwardly and toward each other. Thus, angled panels 18 act as moisture equalizers. The angled panels 18 of each opposing set are vertically spaced apart from each other forming upwardly facing elongated openings 20 (seen best in FIG. 3 with grain present) between adjacent panels 18. Elongated openings 20 allow airflow to pass through one lateral side of each grain flow path between panels 18 through centrally located undulating grain flow path 16 and out of the grain flow path 16 through elongated openings 20 of the opposing lateral side.

A central air plenum 22 is located in the space between a pair of grain flow paths 16 (a first and second grain flow path 16) on the left. An additional central air plenum 22 is positioned in the space between another pair (a third and fourth grain flow path 16) on the right. The sides of each central air plenum 22 is laterally defined by the set of panels 18 forming inner sides of adjacent grain flow paths 16 in the pair.

Each central air plenum 22 can include two dividers 24, 26 separating central plenum 22 into three sub-plenums. The upper sub-plenum located above upper divider 24 can be an exhaust plenum 28. Exhaust plenum 28 includes an exhaust opening (seen best in FIG. 8). Thus, the pressure in exhaust plenum 28 can be at or above atmospheric pressure during operation. The middle sub-plenum can be a heat plenum 32. The high pressure, high heat airflow from fan 14 first flows into heat plenum 32 of central plenum 22. Lower divider 26 can create a sub-plenum below heat plenum 32, which can be a return plenum 34. Air which has passed through a grain column in one of the grain flow paths 16 is pulled from return plenum 34 to an inlet 36 of fan 14 via a return flow air duct 38. Thus, the pressure in return plenum 34 can be below atmospheric pressure during operation. Additionally, the pressure in heat plenum 32 can be higher than the pressure in both exhaust plenum 28 and return plenum 34 during operation.

Enclosures 40, 42 are provided on sides of the grain flow paths 16 opposite that defining central plenum 22. Outer enclosures 40 on opposing sides of the four grain columns are defined by outer walls 44 (seen best in FIG. 6). Inner enclosure 42 can be provided in the space between the pairs of grain flow paths 16 (between second and third grain flow paths 16 in this example). Sides of inner enclosure 42 are defined by sets of panels 18 opposite those forming the sides of central plenum 22.

Enclosures 40, 42 are positioned laterally adjacent high pressure, high heat plenum 32 to capture airflow passing through the adjacent grain flow path 16 from heat plenum 32 via high heat airflow path represented by two-headed arrow 45. Enclosures 40, 42 additionally define a portion of a preheat airflow path represented by arrows 46 once again through an adjacent grain flow path 16 and into exhaust plenum 28. Enclosures 40, 42 further define a portion of a temper airflow path represented by arrows 48 once again through an adjacent grain flow path 16 and into return plenum 34. Thus, air entering central plenum 22 makes two passes through a grain flow path 16 prior to (1) exiting through the exhaust opening 30, or (2) returning via return plenum 34 to fan 14 via return duct 38 for recirculation.

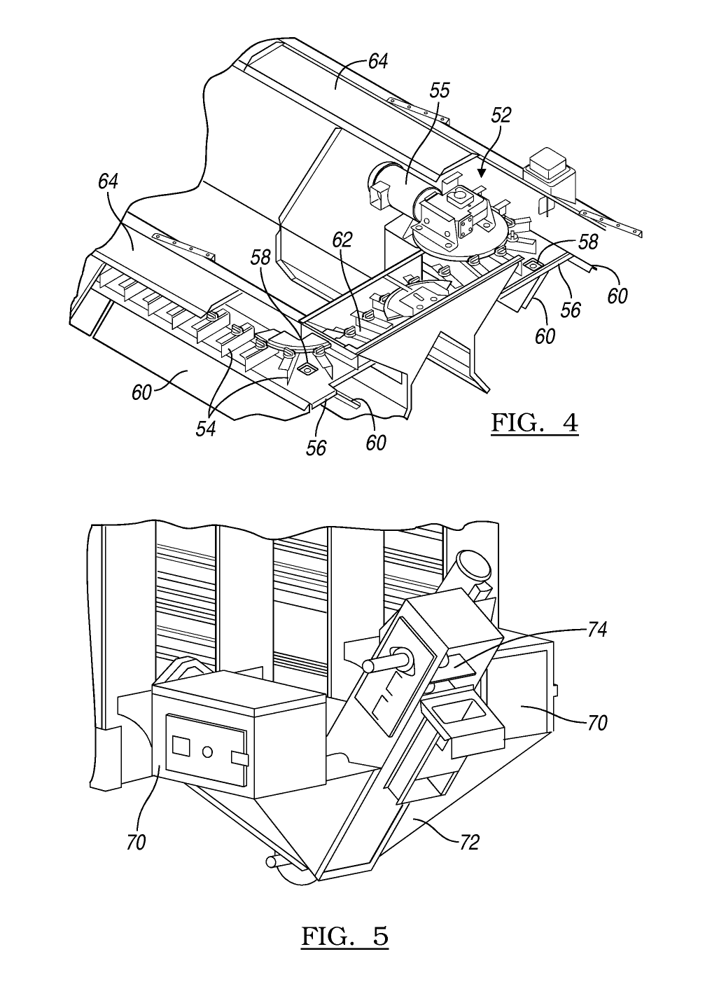

Referring to FIG. 4, a loop drag input conveyor 52 including grain paddles 54 can be provided. A motor 55 drives loop drag input conveyor 52. Paddles 54 are positioned in a loop above two upper shelves 56 extending the length of the grain flow paths 16. Each shelf 52 can include periodic openings 58 allowing grain to fall through the shelf 52. Additionally or alternatively, each shelf 52 can include downwardly angled walls 60 along each side of shelves 52 or below openings 58, with each angled wall 60 extending downwardly toward the top of one of the grain flow paths 16. Thus, each downwardly angled wall 60 can be configured to direct grain from shelves 52 (e.g., over a side or through an opening 58) into the top of one of the grain flow paths 16. A connecting shelf 62 can connect the two upper shelves together at each end of grain dryer 10 to complete the loop arrangement of drag conveyor 52.

A cover can be provided over loop drag conveyor 52, which includes a plurality of panels 64. The loop arrangement of drag conveyor 52 allows grain to be added to the continuous flow dryer 10 at essentially any point along the loop. For example, any cover panel 64 can simply be removed to create a grain input opening to feed grain to loop drag conveyer 52 by which the pairs of grain flow paths 16 are fed. Alternatively, a cover panel 64 including a grain input opening therethrough (not shown) can simply be placed at any point along the loop to feed conveyor 52. Thus, a grain input opening can be located at either end of grain dryer 10, or at any point along either lateral side of grain dryer 10. It can be desirable in some instances to dispose motor 55 opposite in the loop from the location of the grain input. For example, the both motor 55 and the grain input can be on opposite sides at one end of the grain dryer, so that the inputted grain flows along a “U” shape path prior to encountering motor 55 coupled to the paddle drive.

Referring to FIG. 2, shelves 56 and downwardly angled walls 60 by which grain flows into grain flow paths 16 can be seen. In addition, the fact that angled panels 18 define undulating grain flow paths 16 defining a grain column can be understood. Grain flow paths 16 include an outwardly tapered section 17 at the top adjacent exhaust plenum 24. In other words, grain flow paths 16 transitions from a narrower size at the top to a wider size moving down. In this tapered section 17, the space between opposing panels 18 increase with each opposing panel 18 pair moving down. In addition, the lower end of each panel 18 on one side can be laterally spaced from the lower end of opposing panels 18 in the tapered section 17. Dotted lines 66 show this space between the lower ends of opposing panels 18.

Opposing panels 18 forming grain flow paths can also have a uniform width section 19 below tapered section 17 and adjacent return plenum 34 and the heat plenum 32. In uniform width section 19 the lateral spacing between opposing panels 18 forming each grain flow path 16 can be constant. In addition, the lower end of each panel 18 on one side can be vertically aligned with the lower end of opposing panels 18. Dotted line 68 (FIG. 2) shows this alignment of the lower ends of opposing angled panels 18. The transition between tapered section 17 and the uniform width section 19 can occur at the divider between exhaust plenum 28, and heat plenum 32 as shown in the drawings. Alternatively, this transition can occur at a point between upper divider 24 and lower divider 26, such that tapered section 17 extends down to additionally be adjacent an upper part of heat plenum 32, and uniform width section 19 is adjacent a lower part of heat plenum 32.

Horizontally extending elongated airflow openings 20 can also be defined by spaces between vertically adjacent panels 18 on each side of grain flow paths 16. These airflow openings 20 between vertically adjacent panels 18 are present on opposing sides of each grain flow path 16. Openings 20 enable airflow through one side of the grain flow path 16, through a grain column in the path 16, and out through opposing openings 20 of the other lateral side of the grain flow path 16. The relationship between the airflow flowing through a grain column in to and out of various plenums of central plenum 22 is affected by the width of elongated openings 20 created by the spacing between vertically adjacent panels 18. The width of openings 20 can also be sufficiently large that the exiting airflow speed through openings 20 is below that which lifts grain out of grain flow path 16 through openings 20. Thus, there is no need for any screens on the openings 20, despite the fact that the width of openings 20 is larger than the diameter of grain in grain flow path 16. The width of openings 20 can be many times larger than the average diameter of the grain. For example, the width in some cases can preferably be at least 13 mm, can more preferably be at least 20 mm, and can even more preferably be at least 25 mm.

Upper divider 24 and lower divider 26 can also affect the relationship between the airflow flowing through grain columns in grain flow paths 16 in to and out of the various plenums of central plenum 22. For example, each divider 24, 26 can be coupled to one of angled panels 16 defining inner (or opposing) walls of adjacent grain flow paths 16. This helps avoid any airflow path around dividers 24, 26 this is undesirably shortened, resulting in an undesirable short circuit of the airflow from heat plenum 32 to an adjacent plenum 28 or 32 of central plenum 22. The width of elongated openings 20 can also be varied in order to aid in reducing undesirably shortened airflow paths. Differences in the widths of various elongated openings at various locations along grain flow paths 16 can be seen in the drawings. Thus, in some instances the width of openings 20 might vary between 20 mm and 100 mm at various locations along grain flow paths 16.

In addition, dividers 24 can have a sloped or convex upper central surface and can be attached at an upper end of an angled panel 18 on each side. Thus, any grain that might possibly fall from one of elongated openings 20 will fall onto the sloped or convex upper surface of the divider 24 or 26, which will guide the grain back into an adjacent grain flow path 16 via an adjacent elongated opening 20.

Referring to FIGS. 2 and 5, an output metering drag conveyor 70 can be provided at the bottom of each pair of grain flow paths 16. An exemplary metering drag conveyor 70 which can be used is described in detail in U.S. Pat. No. 6,834,442, incorporated herein, in its entirety, by reference. An terminal end of each output metering drag conveyor 70 can include an output that feeds a jump drag mechanism 72 that can joins the outputs of both metering drag conveyors 70 into a single grain output collection point. From there a discharge drag conveyor 74 or auger conveyor can be used to discharge the conditioned grain from the grain dryer 10.

Referring to FIGS. 1, 6 and 7, a combined fan and burner assembly 76 can be positioned at one end of grain dryer 10. Assembly 76 can include induced draft burner 12 positioned between an air intake 78 and centrifugal fan 14. Thus, fan 14 pulls airflow through air intake 78 and into fan 14 through a fan inlet 36. Fan 14 can be a double wheel, double intake centrifugal fan wherein there is a central fan intake 36 on each side of the fan 14. A variable frequency drive motor (not shown) can drive fan 14 at variable speeds.

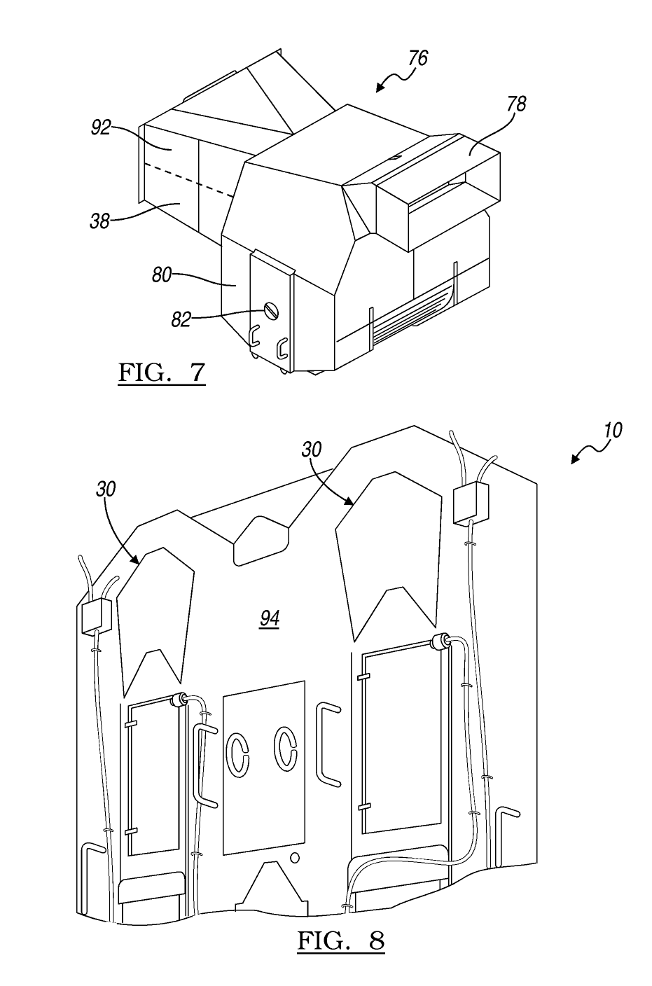

A shroud 80 on each side of assembly 76 provides airflow ducting from burner 12 to inlet 36 of fan 14. Each shroud 80 also provides a portion of return airflow duct 38 for airflow coming from return plenum 34 to inlets 36 of fan 14. Shroud 80 can include an outer member with a central opening 82 (FIG. 7) adjacent the fan wheel bearings 84 (FIG. 6). Central opening 82 in shroud 80 allows unheated air to flow over bearings 84 to cool them. This can greatly reduce negative effects on bearings 82 that might otherwise result from providing burner 12 immediately upstream from fan 14.

Referring to FIGS. 2 and 6, ambient air enters burner 12 via air inlet 78. Air exiting burner 12 flows into inlets 36 at each side of fan 14. The air is directed via shroud 80, which defines an air duct between burner 12 and inlet 36 on each side of fan 14. Thus, a burner airflow path flows through air inlet 78 to burner 12, passes through burner 12, and then from burner 12 flows to inlets 36 of fan 14.

Return airflow paths represented by arrows 86 can provide additional air to inlets 36 of fan 38. Each return airflow path 86 travels within a return air duct 38 from each of the return plenums 34 to one of the inlets 36 on either side of fan 14. As noted above, shroud 80 can operate as part of the return air duct 38, helping to direct air of the return airflow paths 86 into inlets 36 of fan 14. As discussed above, shroud 80 can include a central opening 82 (FIG. 7) providing a bearing cooling flow path to permit some cooler ambient air to additionally enter inlets 36 of fan 14 to flow over fan bearings 84 centrally located in the fan inlet 36. Thus, despite the fact that highly heated air flows into fan inlets 36 directly from burner 12 via burner airflow path, and return warm air flows into inlets 36 of fan 14 via return airflow paths 86, cool air can still flow over fan bearings 84 via central opening 82 in shroud 80.

The air from these three flow paths can be thoroughly mixed in fan 14, thereby outputting air that is of substantially uniform temperature. Fan output airflow paths represented by arrows 90 provide communication between outlet of fan 14 and each heat plenum 32. Fan outlet airflow paths 90 can be provided by a dual duct 92 arrangement as seen in FIG. 6.

Referring to FIG. 2, the airflow through grain columns of each grain flow path 16 is shown in relation to the left pair of grain flow paths 16. It should be understood, however, that the same airflow paths also flow through the other pair of grain columns within grain flow paths 16 in like manner during operation of grain dryer 10. Air first enters heat plenum 32 via fan outlet flow path 86 and flows outwardly through the grain columns of adjacent grain flow paths 16 into the surrounding enclosures 40, 42 as represented by double headed arrow 45. In this case, the left outer enclosure 40 and the inner enclosure 42. Thus, a heat zone is provided in the grain columns in grain flow paths 16 adjacent heat plenum 32 due to heat airflow paths 45.

Enclosures 40, 42 define portions of airflow paths 46, 48 causing the air to then flow again through one of the grain columns of a grain flow path 16 into either exhaust plenum 28 or return plenum 34. In this way, air passes through two grain columns before being exhausted or returned to fan 14 for recirculation. For example, enclosures 40, 42 define portions of preheat airflow path 46 through a grain column from enclosures 40, 42 into exhaust plenum 28. The air of preheat airflow path 46 is still warm. As a result of this warm airflow, a preheat zone is provided in the grain columns of grain flow paths 16 adjacent exhaust plenum 46. The preheat zone helps reduce thermal shock as the grain is being heated in grain dryer 10. Air in the exhaust plenum exits the grain dryer through exhaust opening 30 in the back wall 94 (seen best in FIG. 8) of grain dryer 10.

Enclosures 40, 42 also define portions of temper airflow path 48 through a grain column of adjacent grain flow paths 16 from enclosures 40, 42 into return plenum 34. Air flowing through a grain column into return plenum 34 from enclosures 40, 42 into return plenum 34 is also still warm. This airflow occurs at an upper portion of the grain columns adjacent return plenum 34, providing a temper zone. The temper zone helps reduce thermal shock as the grain is being cooled in grain dryer 10. A cooling zone is next created in grain columns adjacent below the temper zone as a result of ambient air being pulled into return plenum 34 below temper zone via cooling airflow path 50. In cooling zone, ambient air is pulled into return plenum 34 via cooling airflow path 50 through adjacent grain columns via corresponding openings 20. Air within return plenum 34 is pulled back into the fan 14 via return airflow path 86. Thus, return air plenum 34 can typically be at a negative pressure during operation.

As a result of the various airflow paths 45, 46, 48 and 60 through grain columns of grain flow paths 16 defining central plenum 22, grain is first preheated in preheat zone as a result of airflow path 46. Then, as grain moves down grain flow paths 16, the grain is heated in heat zone as a result of airflow path 45. Continuing down grain flow paths 16, the grain is next subjected to a temper zone as a result of airflow path 48, below which airflow path 50 creates a cooling zone portion of grain columns in grain flow paths 16 Thus, the grain can be subjected to four different treatment zones as it flows down through each grain flow path 16.

Cooling airflow path 50, temper airflow path 48, or both, can pick up fines from the grain column and carry them into return plenum 34 and return airflow path 86 to fan 14. After passing through fan 14, any such fines are returned to the grain columns via return airflow paths 90 including fan output airflow paths 90. Thus, return airflow path 86 and fan output airflow path 90, including through fan 14, define a recirculating airflow path in which fines might possibly be present. Since the airflow path through burner 12 is positioned outside the recirculating airflow path, any fines picked up flow through the recirculating airflow path without passing through burner 12. As discussed above, only fresh ambient air flows through burner 12 on its way into the recirculating airflow path. Thus, there is no concern about igniting any fines pulled from a grain column.

Referring to FIG. 8, air flowing into exhaust plenum 28, exits grain dryer 10 through exhaust opening 30 in a central location between a pair of grain flow paths 16 defining exhaust plenum 28. If two or more pairs of grain flow paths 16 are provided in grain dryer 10, exhaust openings 30 can be provided adjacent to each other on a common wall 94. Thus, such adjacent exhaust openings 30 can easily be joined together by a short duct (not seen) to create a single exhaust, if desired.

All of the moisture extracted from the grain exits grain dryer 10 through exhaust opening 30. Thus, it is possible to provide a moisture sensor adjacent each exhaust opening 30 (or adjacent an exhaust opening of such a short exhaust duct joining adjacent exhaust openings) in order to determine the amount of moisture being extracted from the grain in real-time. This can permit adjustments to the grain drying process, such as air temperature and fan speed or air pressure in real time. This can minimize the lag in control mechanisms resulting from analyzing the moisture content and temperature of grain being discharged from grain dryer 10, which only permits making delayed adjustments to the process. Another problem with making adjustments based on analyzing grain being discharged is such adjustments may not be applicable to incoming grain, since new incoming grain may be at a different initial moisture content than the grain that was previously inputted and is currently being discharged.

Just as a single exhaust opening 30 (for each pair of grain columns) or exhausts 30 adjacent each other on a common wall 94 (when multiple pairs of grain columns are present) enables monitoring of all of the air exiting from grain dryer 10 (other than minor losses through air leaks), it also facilitates the inclusion of a single environmental treatment apparatus (not shown) to remove any undesirable products in the air being exhausted from grain dryer 10.

Various methods should be apparent from the above discussion and should be considered part of the disclosure. For example, some methods disclosed herein can involve providing various components of grain dryer 10 disclosed herein. Other methods disclosed herein can involve arranging or connecting various components as disclosed herein. Further methods disclosed herein can involve providing components to create or creating various airflow paths as disclosed herein. Additional methods disclosed herein can involve operating various components as disclosed herein. Providing various components to create the various treatment zones in a grain column are also methods disclosed herein. Moreover, combinations including various aspects of the disclosed methods, including those listed as examples above, are further methods disclosed herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A continuous flow grain dryer comprising:
a pair of adjacent grain flow paths through which the grain flows downwardly under the influence of gravity in a grain column;
a plurality of openings providing airflow paths from one side to an opposing side of each grain flow path;
a central air plenum positioned between the pair grain flow paths;
a first divider separating the central air plenum into an higher pressure zone and a first lower pressure zone;
a first enclosure laterally adjacent a first side of the higher pressure zone and capturing airflow exiting a first of the pair of grain columns from the higher pressure zone, and the first enclosure defining a portion of a first airflow path through which the air passes from the first enclosure back through the first of the pair of grain columns and into the first lower pressure zone;
a second enclosure laterally adjacent a second side of the higher pressure zone and capturing airflow exiting a second of the pair of grain columns from the higher pressure zone, and the second enclosure defining a portion of a first airflow path through which the air passes from the second enclosure back through the second of the pair of grain columns and into the first lower pressure zone.

2. The continuous flow grain dryer of claim 1, wherein each of the at least two grain flow paths are defined by a plurality of panels, and the plurality of openings are defined by elongated spaces between the plurality of panels and the plurality of openings have a width of at least 13 mm.

3. The continuous flow grain dryer of claim 1, further comprising a second divider, which creates a second lower pressure zone in the central air plenum, and wherein the first enclosure defines a portion of a third airflow path through which the air passes from the first enclosure back through the first of the at least two grain columns and into the second lower pressure zone, and wherein the second enclosure defines a portion of a fourth airflow path through which air passes from the second enclosure back through the second of the at least two grain columns and into the second lower pressure zone.

4. The continuous flow grain dryer of claim 3, wherein one of the first or second lower pressure zones of the central air plenum includes an exhaust opening to atmosphere, and wherein an other of the first or second lower pressure zones is coupled to an inlet of a fan to generate negative pressure in the other of the first or second lower pressure zones.

5. The continuous flow grain dryer of claim 4, further comprising a fifth airflow path through which outside ambient air can be drawn through the first of the at least two grain columns and into the other of the first or second lower pressure zones, and a sixth airflow path through which outside ambient air can be drawn through the second of the at least two grain columns and into the other of the first or second lower pressure zones.

6. The continuous flow grain dryer of claim 3, wherein during operation airflow passing back and forth between the central plenum and the first and second enclosures creates a preheat zone in an upper portion of the pair of grain flow paths, a heat zone in the pair of adjacent flow paths below the preheat zone, and a temper zone in the pair of adjacent flow paths below the heat zone.

7. The continuous flow grain dryer of claim 6, wherein during operation, ambient airflow passing into the central plenum via the plurality of openings creates a cooling zone below the temper zone.

8. A continuous flow grain dryer comprising:
a central plenum defined by a pair of adjacent grain flow paths and separated by a divider into a heat plenum and a return plenum;
an exhaust airflow path, wherein during operation, some of the air fed into the heat plenum is exhausted to the atmosphere;
a recirculating airflow path from the return plenum through a fan and back to the heat plenum, wherein during operation, the return plenum is fed by airflow passing through grain columns in the pair of adjacent grain flow paths and
a burner outside the recirculating airflow path providing heated air to the fan via a burner airflow path that joins to the recirculating airflow path, wherein during operation, the burner is fed by ambient airflow from a burner inlet without any recirculating airflow passing through the burner.

9. The continuous flow grain dryer of claim 8, wherein a fan shroud defines a portion of the recirculating airflow path and a portion of the burner airflow path adjacent an inlet of the fan, and the fan shroud having a central opening adjacent a centrally located fan bearing to permit ambient air to pass into the inlet of the fan and flow over the bearings.

10. The continuous flow grain dryer of claim 8, further comprising an enclosure on each opposing lateral side of the pair of adjacent grain flow paths; each enclosure defining a portion of an airflow path from the enclosure into the return plenum, wherein during operation, air passes from the heat plenum through one of the pair of adjacent grain flow paths into one of the enclosures and from the one of the enclosures again through the one of the pair of adjacent grain flow paths into the return plenum, whereby the air passes through an adjacent grain flow path twice prior to entering the recirculating airflow path.

11. The continuous flow grain dryer of claim 10, wherein the central plenum is further separated by another divider to provide an exhaust plenum including an exhaust opening, and wherein during operation, air passes from the heat plenum through the one of the pair of adjacent grain flow paths into the one of the enclosures and from the one of the enclosures again through the one of the pair of adjacent grain flow paths into the return plenum, whereby air passes through an adjacent grain flow path twice prior to exiting the grain dryer through the exhaust opening.

12. The continuous flow grain dryer of claim 11, wherein the exhaust opening is located in a portion of an exterior wall of the grain dryer defining the exhaust plenum, wherein the exhaust plenum is centrally located between the pair of grain flow paths.

13. The continuous flow grain dryer of claim 11, wherein the exhaust opening provides a single exhaust point from the central plenum, and wherein all air exiting the grain dryer exits from the central plenum.

14. A continuous flow grain dryer comprising:
four longitudinally extending grain flow paths through which grain flows downwardly under the influence of gravity in a grain column, each side of the four grain flow paths being defined by a series of angled panels;
a plurality of elongated openings defined between each of the series of angled panels and permitting airflow through one side of each grain flow path, through each grain column, and through an opposing side of each grain flow path; and
a central air plenum provided in each space between a first and second of the four grain flow paths and between a third and forth of the four grain flow paths;
two dividers separating each central air plenum into a exhaust plenum at the top, a heat plenum in the middle, and a return plenum at the bottom;
an outer wall positioned on each opposing side of the four grain flow paths and laterally adjacent a corresponding heat plenum forming an outer enclosure capturing airflow exiting an adjacent grain column from an outer side of an adjacent heat plenum;
an inner enclosure provided in each space between the second and the third of the four grain flow paths laterally adjacent each heat plenum to capture airflow exiting the second and third grain columns from an inner side of the heat plenum;
wherein each enclosure defines a portion of a preheat airflow path through which air passes from the enclosure back through an adjacent grain column and into one of the exhaust plenums to create a preheat zone at the upper end of each grain column, and
wherein high heat airflow paths from each heat plenum through adjacent grain columns into the enclosures create a high heat zone below the preheat zone, and
wherein each enclosure defines a portion of a temper airflow path through which air passes from each enclosure back through an adjacent grain column and into one of the return plenums to create a temper zone below each high heat zone; and
wherein ambient airflow paths are defined by a group of the plurality of openings at the lower end of each grain column through which ambient air passes through each grain column into one of the return plenums to define a cooling zone below each temper zone.

15. The continuous flow grain dryer of claim 14, wherein each of the plurality of elongated openings has a width of at least 13 mm, and wherein screens are not provided over the plurality of elongated openings.

17. The continuous flow grain dryer of claim 14, wherein a common wall defines a portion of each exhaust plenum, and wherein each exhaust opening is in the common wall adjacent to each other.

18. The continuous flow grain dryer of claim 17, wherein the only air exit provided for the grain dryer are the exhaust openings adjacent each other in the common wall.

19. The continuous flow grain dryer of claim 14, wherein the grain flow paths define undulating columns and the angled panels operate as moisture equalizers.

20. The continuous flow grain dryer of claim 14, further comprising a recirculating airflow path from the return plenum through a fan and back to the heat plenum, wherein during operation, the return plenum is fed by airflow passing through grain columns in the pair of adjacent grain flow paths and; a burner outside the recirculating airflow path providing heated air to the fan via a burner airflow path that joins to the recirculating airflow path, wherein during operation, the burner is fed by ambient airflow from a burner inlet without any recirculating airflow passing through the burner.
